(19) United States
(12) Patent Application Publication
(10) Pub. No.: US 2025/0371880 A1
(43) Pub. Date: Dec. 4, 2025

(54) MONITORING APPARATUS AND MONITORING APPARATUS METHOD

(71) Applicant: Hitachi Channel Solutions, Corp., Tokyo (JP)

(72) Inventors: Takeshi KANAGAWA, Tokyo (JP); Yuki MATSUI, Tokyo (JP); Toshiyuki EDAKAWA, Tokyo (JP); Yoshimasa IMAI, Tokyo (JP); Hideaki UMEMURA, Tokyo (JP); Hiroki HORIUCHI, Tokyo (JP)

(73) Assignee: Hitachi Channel Solutions, Corp., Tokyo (JP)

(21) Appl. No.: 18/874,992

(22) PCT Filed: Mar. 20, 2023
(86) PCT No.: PCT/JP2023/011010

§ 371 Date: Dec. 13, 2024

(30) Foreign Application Priority Data
Jun. 17, 2022 (JP) 2022-098471

(51) Int. Cl. G06V 20/52; G06T 7/246; G06T 7/73; G06V 40/16; G06V 40/20; G07F 19/00

(52) U.S. Cl. CPC G06V 20/52; G06T 7/246; G06T 7/73; G06V 40/174; G06V 40/20; G07F 19/207; G06T 2207/30201; G06T 2207/30232

(57) ABSTRACT

An ATM that internally has a function as a monitoring apparatus includes: an imaging unit that includes, in an imaging range, an operator of a money handling transaction apparatus and surroundings of the operator; an posture detection unit that detects a joint position related to a skeleton in an image of a person included in an imaging result of the imaging unit; a determination unit that determines a motion of the person, based on a detection result of the posture detection unit; and an instruction unit that generates an instruction that indicates a response to the person, based on a determination result of the determination unit. The monitoring apparatus can achieve highly functional monitoring in relation to operations on the money handling transaction apparatus.

### TECHNICAL FIELD

The present invention relates to a monitoring apparatus and a monitoring method that monitor an operator at a money handling transaction apparatus and their surroundings.

### BACKGROUND ART

Conventionally, there has been a technique of monitoring operation using an image. For example, Patent Literature 1 describes “an abnormal action detecting apparatus used for an amusement machine operated by an operator at an operator position, the apparatus including the following elements: (1) an imaging unit that obtains image information including a subject at the operator position; (2) a subject motion detection unit that detects subject motion information indicating the motion of the subject, based on the image information obtained from the imaging unit; and (3) an abnormal action determination unit that determines occurrence of an abnormal action by the operator, based on the subject motion information detected by the subject motion detection unit.”

### CITATION LIST

### Patent Literature

[Patent Literature 1]

Japanese Patent Laid-Open No. 2001-070594

### SUMMARY OF INVENTION

### Technical Problem

However, according to the conventional art, countermeasures against malicious activities on a money handling transaction apparatus, and support for operation cannot be sufficiently provided.

Malicious activities on the money handling transaction apparatus vary, such as looking over an operator's shoulder, attaching a device for performing a fraud, and destructive actions.

Support, such as operation guidance and scam prevention, is required to be performed in real time when the operator gets lost in operation or tries to perform a transfer operation due to a bank transfer scam.

Furthermore, there is a possibility that people waiting for their turn are around the operator at the transaction apparatus. Unlike passersby, people waiting for their turn reside around the operator. Accordingly, cases in which it is difficult to distinguish them from the operator can occur.

Techniques typified by Patent Literature 1 can neither identify various malicious activities and take measures against them nor provide support in accordance with the state of the operator. Based on them, the reality is only that monitoring of the transaction apparatus includes simply taking and recording an image, and using it for a post survey.

Accordingly, an object of the present invention is to provide a monitoring apparatus and a monitoring method that are highly functional and enable anti-fraud measures, operation support and the like in relation to operation on the money handling transaction apparatus.

### Solution to Problem

To achieve the object described above, one typical monitoring apparatus in the present invention includes: an imaging unit that includes, in an imaging range, an operator of a money handling transaction apparatus and surroundings of the operator; an posture detection unit that detects a joint position related to a skeleton in an image of a person included in an imaging result of the imaging unit; a determination unit that determines a motion of the person, based on a detection result of the posture detection unit; and an instruction unit that generates an instruction that indicates a response to the person, based on a determination result of the determination unit, wherein the determination unit determines the motion of the person by comparing the detection result of the posture detection unit with operator motion pattern data that is defined in advance about a motion of the operator, and the instruction unit refers to instruction pattern data that associates the motion with the instruction, and generates the instruction.

One typical monitoring method in the present invention causes a monitoring apparatus to perform: an imaging step of imaging an operator of a money handling transaction apparatus, and surroundings of the operator; an posture detection step of detecting a joint position related to a skeleton in an image of a person included in an imaging result of the imaging step; a determination step of determining a motion of the person, based on a detection result of the posture detection step; and an instruction step of generating an instruction that indicates a response to the person, based on a determination result of the determination step, wherein the determination step determines the motion of the person by comparing the detection result of the posture detection step with operator motion pattern data that is defined in advance about a motion of the operator, and the instruction step refers to instruction pattern data that associates the motion with the instruction, and generates the instruction.

### Advantageous Effects of Invention

According to the present invention, highly functional monitoring can be achieved in relation to the operation on the money handling transaction apparatus. Problems, configurations, and advantageous effects other than those described above are clarified by the following description of embodiments.

### BRIEF DESCRIPTION OF DRAWINGS

FIG. 1 is a diagram illustrating monitoring of an automatic teller machine.

FIG. 2 is a configuration diagram showing a configuration of an ATM.

FIG. 3 is a flowchart showing processing procedures of the ATM.

FIG. 4 is a diagram illustrating the details of instruction pattern data.

FIG. 5 is a specific example of an image and operation (first).

FIG. 6 is a specific example of an image and operation (second).

FIG. 7 is a specific example of an image and operation (third).

FIG. 8 is a specific example of an image and operation (fourth).

FIG. 9 is a specific example of an image and operation (fifth).

FIG. 10 is a configuration diagram showing a configuration of an ATM in Example 2.

FIG. 11 shows a specific example of operation support (first).

FIG. 12 shows a specific example of operation support (second).

FIG. 13 shows a specific example of operation support (third).

FIG. 14 is a diagram illustrating sharing of a fraudulent history.

FIG. 15 is a diagram illustrating detection of an object.

FIG. 16 is a diagram illustrating displaying of an advertisement.

### DESCRIPTION OF EMBODIMENTS

Hereinafter, Examples are described with reference to the drawings.

### Example 1

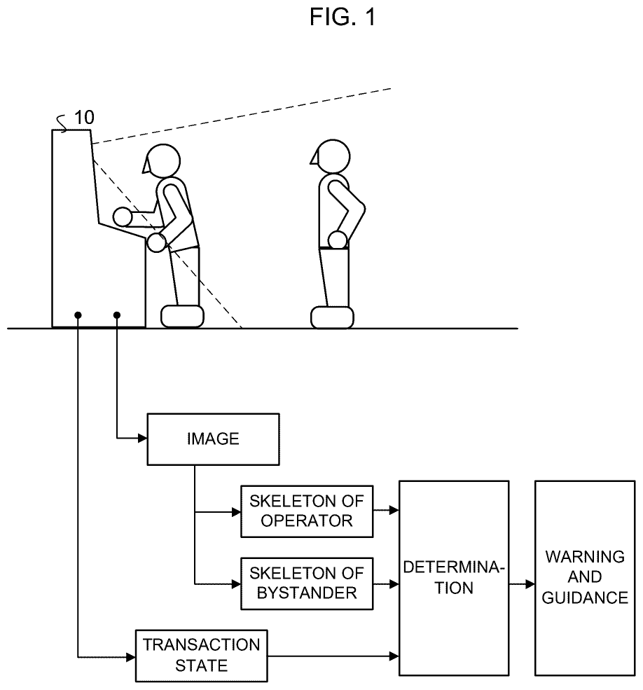

FIG. 1 is a diagram illustrating monitoring of an automatic teller machine (ATM). The ATM 10 shown in FIG. 1 is a money handling transaction apparatus, and internally has a function as a monitoring apparatus that monitors an operator and their surroundings.

The ATM 10 includes, in the imaging range, an imaging unit that includes the operator and their surroundings. The ATM 10 detects the skeleton of the operator and the skeletons of bystanders from an image that is an imaging result by the imaging unit. The skeleton of the operator indicates the posture of the operator. Likewise, the skeletons of the bystanders respectively indicate their postures.

The ATM 10 determines the motions of the operator and the bystanders, based on the skeleton of the operator, the skeletons of the bystanders, the state of a transaction and the like, and generates an instruction indicating a response to the operator and the bystanders, based on the determination result. The instruction includes a notification in case the operator is committing a malicious activity, attracting the operator's attention in case a bystander is exhibiting a suspicious behavior, and operation guidance for the operator.

Countermeasures against malicious activities can be taken and support for the operation can be achieved by imaging the operator at the transaction apparatus and their surroundings, identifying the skeleton of each person and determining the motion, and issuing a warning and providing guidance in response to the motion as described above.

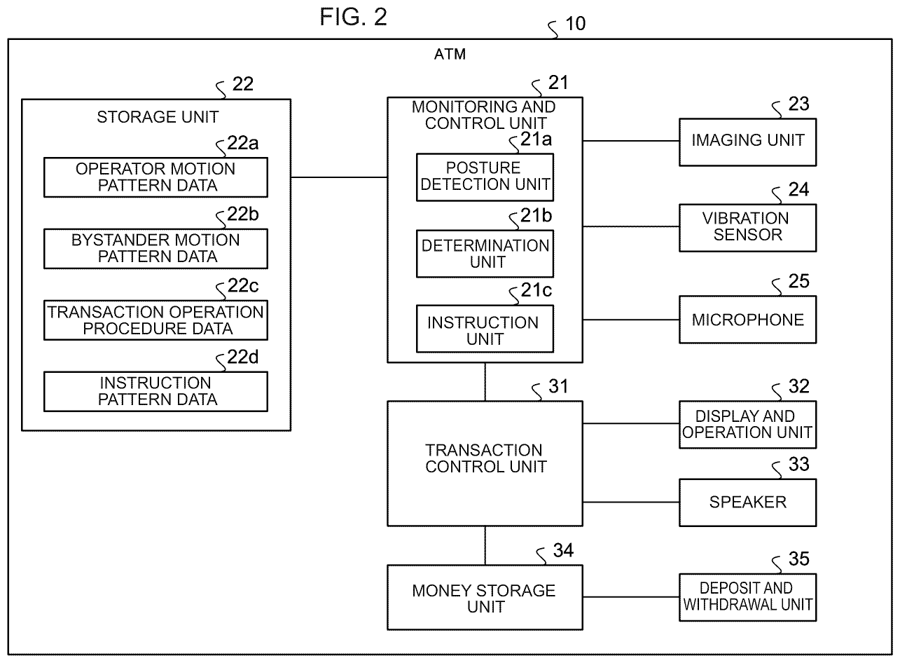

FIG. 2 is a configuration diagram showing the configuration of the ATM 10. The ATM 10 includes a monitoring and control unit 21, a storage unit 22, an imaging unit 23, a vibration sensor 24, a microphone 25, a transaction control unit 31, a display and operation unit 32, a speaker 33, a money storage unit 34, and a deposit and withdrawal unit 35.

The transaction control unit 31 is a control unit that handles various transactions including money handling transactions. The transactions include a deposit, a withdrawal, a transfer, a balance inquiry, and a bank book update. Note that a card reader, a bank book processing unit, a communication unit, a receipt printer and the like, which are not shown, can be coupled to the transaction control unit 31, and can be used as needed for a transaction.

The display and operation unit 32 is coupled to the transaction control unit 31, and issues display output to the operator, and accepts input from the operator. The display and operation unit 32 includes a touch panel display, and buttons. The speaker 33 is coupled to the transaction control unit 31, and provides audio output to the operator.

The money storage unit 34 stores money, i.e., banknotes and coins, by money type. The deposit and withdrawal unit 35 performs deposits and withdrawals of money. After money is fed into the deposit and withdrawal unit 35, the money storage unit 34 counts and stores the fed money by money type, and notifies the transaction control unit 31 of the total amount and the inventory amounts by money type. Under control by the transaction control unit 31, the money storage unit 34 withdraws money to the deposit and withdrawal unit 35.

The monitoring and control unit 21 is coupled to the transaction control unit 31, the storage unit 22, the imaging unit 23, the vibration sensor 24, and the microphone 25.

The imaging unit 23 is a camera that includes, in the imaging range, the operator and the surroundings of the operator, and outputs an image that is an imaging result to the monitoring and control unit 21.

The vibration sensor 24 detects the vibrations of the ATM 10, and outputs a detection result to the monitoring and control unit 21.

The microphone 25 collects sound from the surroundings of the ATM 10, and outputs the sound collection result to the monitoring and control unit 21.

The storage unit 22 is, for example, a hard disk device, and stores operator motion pattern data 22a, bystander motion pattern data 22b, transaction operation procedure data 22c, and instruction pattern data 22d.

The operator motion pattern data 22a is data that is defined in advance about operations when the operator operates the ATM 10.

The bystander motion pattern data 22b is data that is defined in advance about the motions of bystanders present around the operator. The motions of the bystanders include, for example, appropriate motions such as waiting for turns, and motions suggesting a malicious activity such as looking over.

The transaction operation procedure data 22c is data that indicates the operation procedures of transactions of the ATM 10. For example, the operation procedure indicates the order of operations for performing the transaction. For example, deposit operation procedures are “accepting a card”, “inputting the amount”, and “picking up money”. It is obtained from the transaction control unit 31 whether each operation has been executed. The motions in the operations may be registered in the operator motion pattern data 22a.

The instruction pattern data 22d is data that associates the motions of the operator and the bystanders with instructions. The details of the instruction pattern data 22d are described later.

The monitoring and control unit 21 is a control unit that controls monitoring of the ATM 10, and may be achieved by, for example, a CPU (Central Processing Unit). The monitoring and control unit 21 achieves the functions of the posture detection unit 21a, the determination unit 21b, and the instruction unit 21c.

The posture detection unit 21a detects a joint position related to a skeleton in an image of each person included in the imaging result of the imaging unit 23. Specifically, the posture detection unit 21a extracts an image of the person from the taken image, and detects the joint position of the skeleton. In this case, the distance to the person may be identified depending on the position of the image of the person. For example, it can be identified whether the operator is present adjacent to the ATM 10, by the size of the image in the taken image, or the like. The distance of each bystander to the ATM 10 can be estimated from the size of the image in the taken image and on the positions of the feet.

The determination unit 21b determines the motion of the person, based on the detection result of the posture detection unit 21a.

The determination unit 21b compares the detection result of the posture detection unit 21a with the operator motion pattern data 22a, and determines the motion of the operator.

The determination unit 21b compares the detection result of the posture detection unit 21a with the bystander motion pattern data 22b, and determines the motion of each bystander.

The determination unit 21b may further use the state of the transaction obtained from the transaction control unit 31, and determine the motion of the person. For example, it can be determined that a card inserting motion is performed from the posture of the operator person and on the state of the card reader.

Furthermore, the determination unit 21b can compare the detection result of the posture detection unit 21a with the transaction operation procedure data 22c and identify the state of the transaction, and further use the state of the identified transaction and determine the motion of the person.

Moreover, the motion of the person can be determined further using the outputs of the microphone 25 and the vibration sensor 24. For example, if the operator is squatting in front of the ATM 10 and sounds and vibrations are detected, it can be determined that they are possibly breaking the money storage unit 34.

The instruction unit 21c refers to the instruction pattern data 22d based on the determination result of the determination unit 21b, and generates an instruction that indicates a response to the operator and the bystanders.

The instruction unit 21c can refer to the instruction pattern data 22d, and generate an instruction in response to the motion of the operator and the motions of the bystanders.

The instruction unit 21c can generate an instruction for a situation identified according to a combination of the motion of the operator and the motions of the bystanders.

For example, if the bystanders are waiting for their turn with the operator being squatting in front of the ATM 10, the operator is highly possibly performing a motion, such as picking up a forgotten item, which is not malicious activity.

On the other hand, if the bystanders are performing a motion of being alert to the surroundings with the operator being squatting in front of the ATM 10, the operator and the bystanders are possibly performing fraudulent actions in corporation.

If the motion of the person is a fraudulent action, the instruction unit 21c can generate an instruction for at least any of a notification, a warning, deferment, and attracting attention.

If the operation of the operator deviates from an appropriate operation procedure, the instruction unit 21c can generate an instruction for supporting the operation of the operator.

Furthermore, the instruction unit 21c can generate an instruction for canceling and starting a power saving mode of the ATM 10, based on an approach and a departure of the operator.

Specific examples of these instructions are described later.

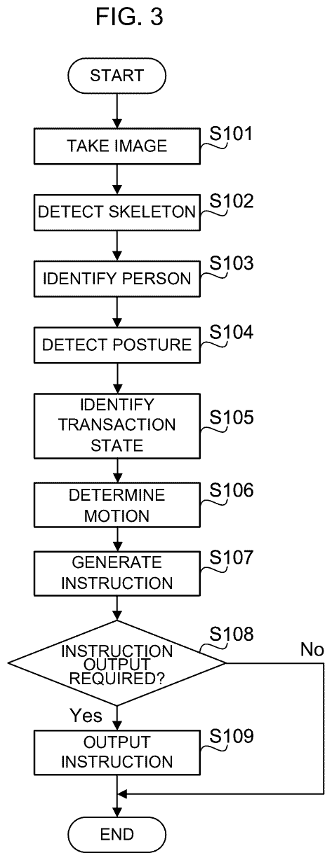

FIG. 3 is a flowchart showing processing procedures of the ATM 10. The ATM 10 repetitively executes the processes of steps S101 to S109.

After the processing is started, first, the imaging unit 23 takes an image (step S101). The posture detection unit 21a detects a skeleton from an imaging result of the imaging unit 23 (step S102), and identifies the operator and bystanders (step S103). The posture detection unit 21a detects the postures of the operator and the bystanders from the joint position relationship.

The determination unit 21b identifies the state of a transaction by obtaining it from the transaction control unit 31 or by referring to the transaction operation procedure data 22c (step S105).

The determination unit 21b uses the posture of the operator, the postures of the bystanders, the state of the transaction and the like, and determines the motions of the operator and the bystanders (step S106).

The instruction unit 21c refers to the instruction pattern data 22d based on the motions of the operator and the bystanders, and generates an instruction if required (step S107). When the instruction is generated, the instruction is required to be output (step S108: Yes). Accordingly, the generated instruction is output (step S109), and the processing is finished. If any instruction is not generated (step S108: No), the processing is finished as it is.

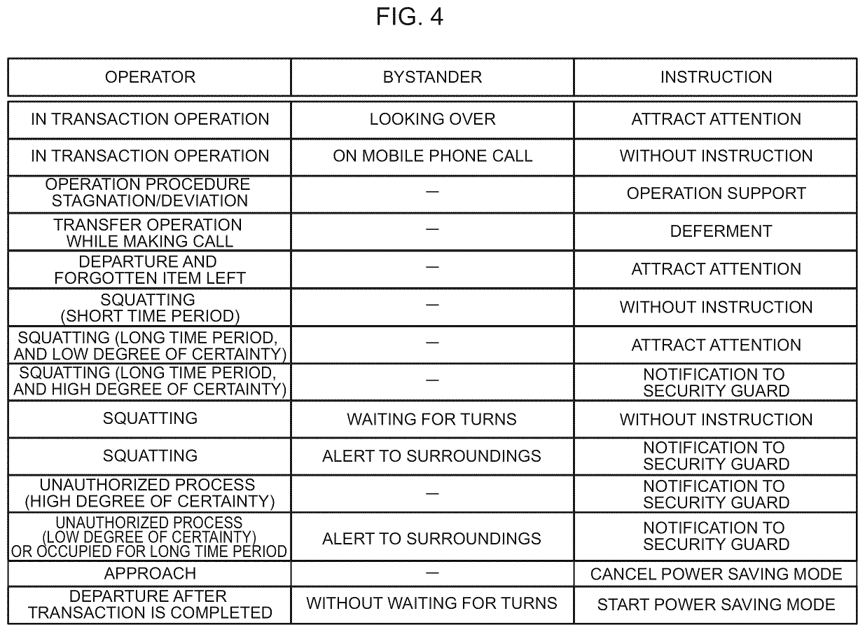

FIG. 4 is a diagram illustrating the details of the instruction pattern data. As shown in FIG. 4, the instruction pattern data 22d indicates that if the motion of the operator is “IN TRANSACTION OPERATION” and the motion of the bystander is “LOOKING OVER”, instruction for attracting the operator's attention is generated. Specifically, an instruction for causing the display and operation unit 32 to output an indication of being looked over the shoulder is preferable.

On the other hand, if the motion of the operator is “IN TRANSACTION OPERATION” and the motion of the bystander is “ON MOBILE PHONE CALL”, the instruction pattern data 22d determines that no instruction is required.

If the motion of the operator is “OPERATION PROCEDURE STAGNATION/DEVIATION”, the instruction pattern data 22d indicates that an instruction for operation support is generated. For example, if it is stagnant in procedures indicated by the transaction operation procedure data 22c, the display and operation unit 32 is caused to output an indication for guiding the next procedure.

The instruction pattern data 22d indicates that if the motion of the operator is “TRANSFER OPERATION WHILE MAKING CALL”, an instruction for deferment is generated. For example, an indication, such as “Wait a moment. A staff member will be with you.” is provided, which can facilitate prevention of a bank transfer scam. A notification may also be issued together. Alternatively, the operator may be directly notified that a bank transfer scam is suspected.

The instruction pattern data 22d indicates that if the motion of the operator is “DEPARTURE AND FORGOTTEN ITEM LEFT”, an instruction for attracting attention is generated. For example, if after a card is inserted and an operation is performed, the operator leaves the ATM 10 without performing a motion of picking up the card, it can be estimated that the card is left behind. In this case, an instruction for causing the speaker 33 to output a sound, such as “Card is left behind”, through the speaker 33 is preferable.

The instruction pattern data 22d indicates that if the motion of the operator is squatting for a short time period, no instruction is issued. This is because there is a possibility that the forgotten item is being picked up or the like.

The instruction pattern data 22d indicates that if the motion of the operator is squatting for a long time period, different measures are taken depending on the degree of certainty of squatting determination. There is a possibility that squatting for a long time period is an abnormal action, such as a destructive action, to the money storage unit 34. Accordingly, the instruction pattern data 22d associates a case having a low degree of certainty with an instruction for attracting attention (for example, an audible alarm is output from the speaker 33), and associates a case having a high degree of certainty with an instruction for notifying a security guard.

If the motion of the operator is squatting, different measures may be taken depending on the motion of the bystander. The instruction pattern data 22d indicates that if the motion of the operator is “SQUATTING” and the motion of the bystander is “WAITING FOR TURN”, no instruction is required. On the other hand, the instruction pattern data 22d associates a case in which the motion of the operator is “SQUATTING” and the motion of the bystander is “ON LOOKOUT FOR PERIMETER” with “NOTIFICATION TO SECURITY GUARD”.

The motions of the operator may include a fraudulent process. The fraudulent process is, for example, a motion of attaching, to the ATM 10, a machine for fraudulently reading a card. The instruction pattern data 22d indicates that if it is determined that a fraudulent process is performed by the operator with a high degree of certainty, a notification is issued to the security guard. Notification to the security guard is indicated if a fraudulent process by the operator is determined with a low degree of certainty or the operator occupies the front of the ATM 10 for a long time period, and the bystander is on the lookout for the perimeter.

Determination of a destructive action and a fraudulent process to the money storage unit 34 can further use the outputs of the vibration sensor 24 and the microphone 25. If vibrations or a sound caused by a destructive action or a fraudulent process is detected, the degree of certainty of determination that a destructive action or a fraudulent process is performed can be improved.

Furthermore, the instruction pattern data 22d indicates that an instruction for canceling and starting the power saving mode of the ATM 10 is generated based on an approach and a departure of the operator. The power saving mode is a mode for reducing the power consumption of unnecessary functions in a state in which the operator is absent.

Specifically, the instruction pattern data 22d indicates that when an approach of the operator is detected, an instruction for canceling the power saving mode is generated. It is also indicated that if the operator has finished the transaction and left, and no bystander is waiting for their turn, an instruction for starting the power saving mode is generated.

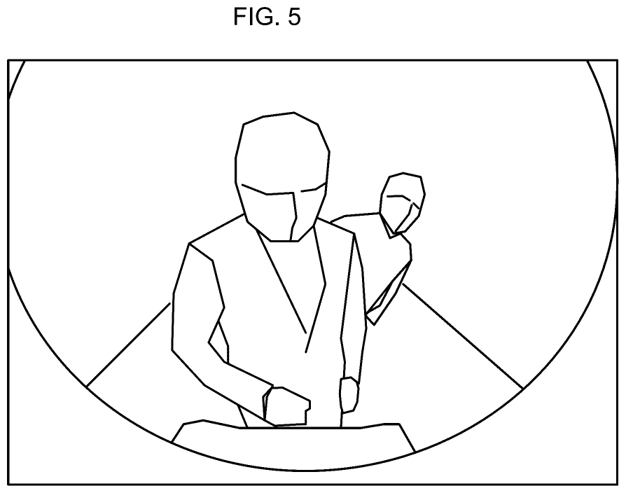

Next, referring to FIGS. 5 to 9, specific examples of images and operations are described.

In FIG. 5, the posture detection unit 21a detects the skeleton positions of each person who are on the screen and includes joints and the like of the head, left and right shoulders, and left and right arms.

The determination unit 21b determines whether each person is a person (the operator of the ATM) facing the ATM or another bystander, based on, for example, the size of the triangle connecting the head and both the shoulders, and its position on the screen.

Furthermore, for each person, the determination unit 21b compares skeleton information detected by the detection unit with candidates of predefined specific postures or behaviors, and calculates the degrees of matching with these candidates. If the degree of matching of the candidate having the highest degree of matching is equal to or larger than a constant value, this candidate is determined as the posture of the person. If the degree of matching is less than the constant value, it is determined that there is no candidate or the posture is unknown.

For example, the determination unit 21b determines that the person on a near side is the operator facing the ATM based on the size and position on the screen, and a card inserting operation into the ATM 10 is performed based on the skeleton information. A person on a far side is determined as a bystander around the ATM 10, and is determined that they are looking into the screen of the ATM 10.

The instruction unit 21c issues, to the transaction control unit 31, an instruction of the behavior predefined for a corresponding piece of information about which the determination unit 21b issues a report. For example, insertion of the card by the operator of the ATM 10 is an action in a range of normal ATM operations. Accordingly, in this case, no instruction is generated. The action of the bystander of the ATM 10 looking into the screen is an abnormal action. Accordingly, a warning is displayed on the screen of the ATM 10. In this case, based on priorities predefined for definition information on these people, for example, the instruction for the action of the bystander is prioritized, and the instruction unit instructs a higher-level apparatus to display a warning on the screen of the ATM 10. The priorities are set, for example, in an order of a notification, a warning, deferment, attracting attention, operation support, and no instruction. If there are multiple instructions corresponding to the determination result, the instruction with the highest one may be generated.

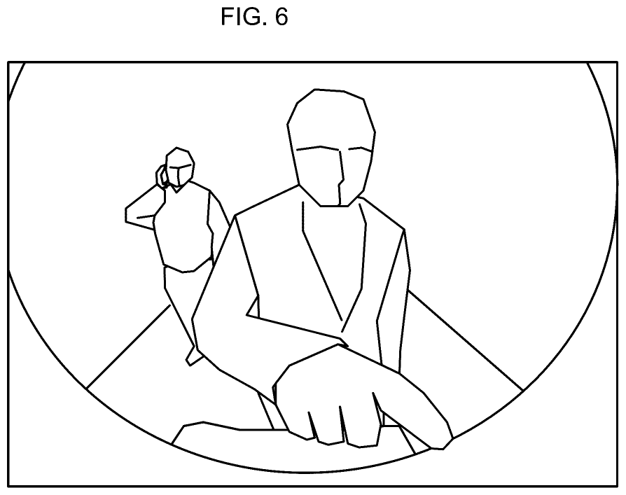

In FIG. 6, the determination unit 21b, for example, determines that the person on the near side is the operator of the ATM based on the size and position on the screen, and they are touching a button on the screen of the ATM 10 based on the skeleton information. Likewise, a person on the far side is determined as a bystander around the ATM 10, and is determined that they are on a mobile phone.

For example, if the operator of the ATM 10 is touching a button on the screen of the ATM 10, the instruction unit 21c issues no instruction because the action is in the range of normal ATM operations. Also in a case in which the bystander around the ATM 10 is on a mobile phone call, no instruction is issued because this is a normally performed action. Based on these pieces of definition information, the instruction unit 21c issues no instruction to the transaction control unit 31.

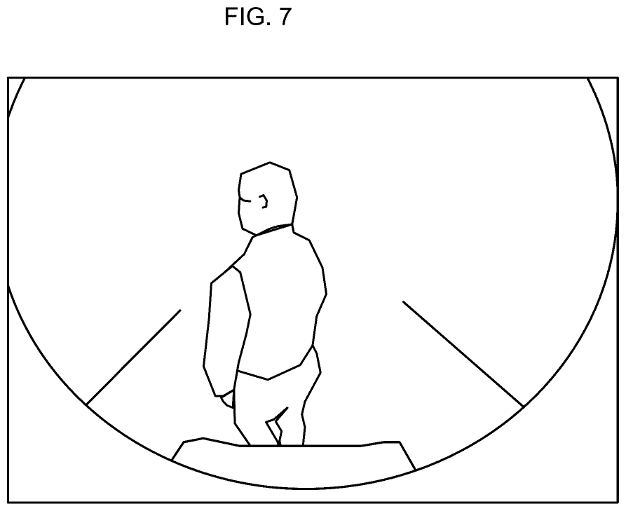

In FIG. 7, the determination unit 21b determines that the person in the image is the operator of the ATM 10, and they are turning around and leaving.

The instruction unit 21c obtains information about the progress situation of the operation performed by the operator from, for example, the transaction control unit 31. For example, if information indicating that the operator has finished the transaction is obtained, no instruction is required to be output to the transaction control unit 31. Alternatively, if information indicating that the operator has not picked up withdrawn money yet is obtained, an instruction for making a ringtone for attracting attention using the speaker 33 is issued.

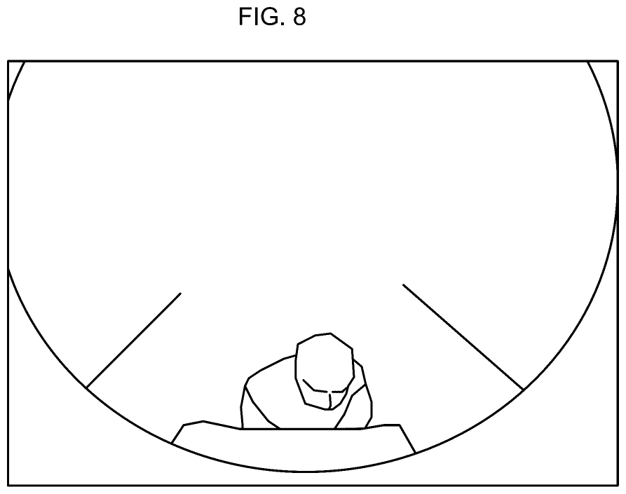

In FIG. 8, the determination unit determines that the person in the image is a person facing the ATM 10, i.e., an operator for convenience sake, based on the size and the position on the screen, and also determines that they are squatting in front of the ATM 10.

The instruction unit 21c determines that the operator's squatting action is an abnormal action, such as a destructive action to a safe, and instructs, for example, the transaction control unit 31 to call the security guard.

For example, if the squatting time period is short, the instruction unit 21c regards the motion as a normal motion, such as picking up a dropped item, and issues an instruction for doing nothing. If the time period is equal to or longer than a constant value, this unit determines that there is a possibility of a motion of a destructive action, such as safe fusing and cutting, and notifies the security guard. Thus, depending on the situations such as the duration of an action, the content of the instruction can be changed.

If the degree of certainty of matching with the squatting posture candidate is low, it is not necessarily a posture for a destructive action. Accordingly, for example, an audible alarm is issued from the ATM. Thus, the instruction unit 21c issues an instruction for performing a motion for attracting attention or preventing a crime. If the degree of certainty of matching is high, it is regarded as a posture for a destructive action, and an instruction for notifying the security guard is issued. Thus, depending on the matching degree of certainty, the content of the instruction can be changed.

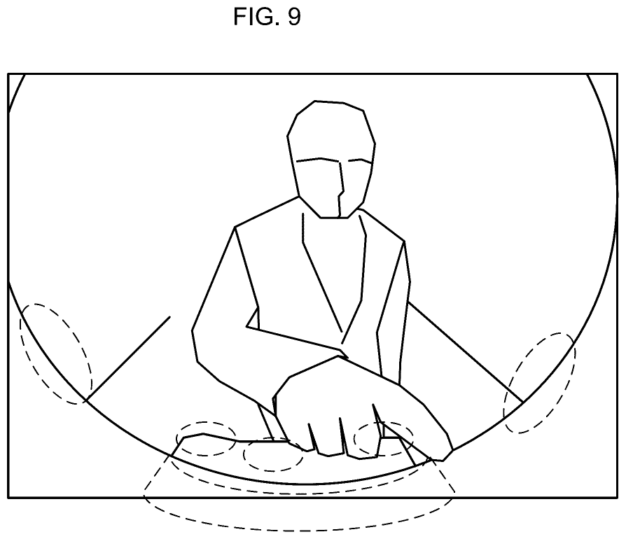

In FIG. 9, the determination unit 21b determines that the person in the image is the operator facing the ATM 10, and which part of the ATM 10 is operated, from the skeleton information. In FIG. 9, areas surrounded by broken lines respectively indicate a touch panel display, switches, a card reader, a money deposit and withdrawal port, a receipt printer and the like. If any of the areas surrounded by the broken lines matches the position of a hand of the operator, it can be determined which operation the operator performs.

If the determined operation is different from the order indicated by the transaction operation procedure data 22c, there is a possibility of an operational error. Accordingly, the instruction unit 21c issues an instruction to encourage the operator to operate correctly.

### Example 2

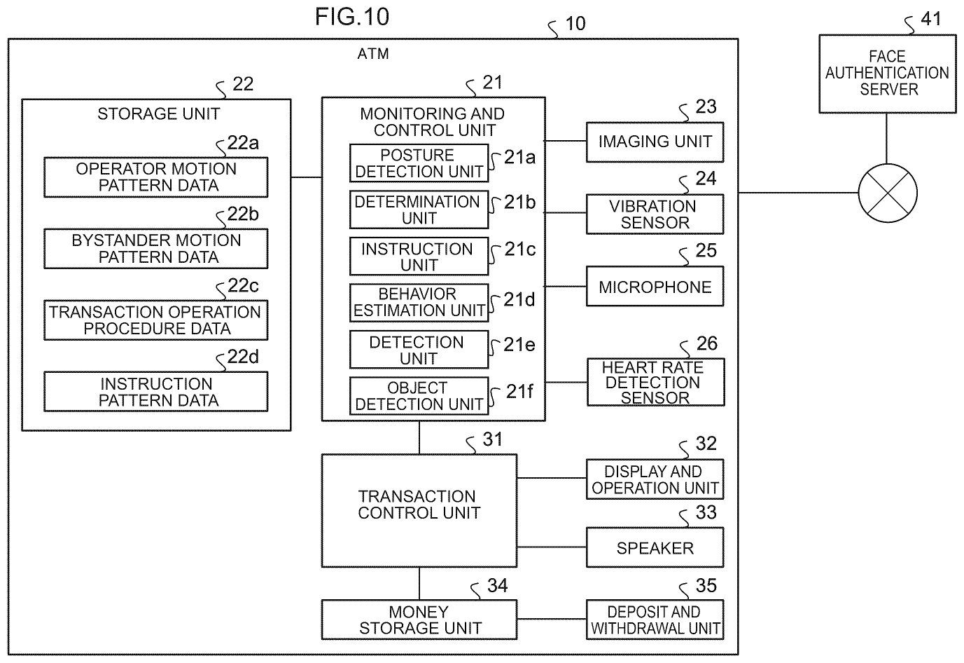

FIG. 10 is a configuration diagram showing a configuration of an ATM in Example 2. The ATM 10 shown in FIG. 10 has a configuration that includes the configuration shown in FIG. 2, and additionally includes a behavior estimation unit 21d, a facial expression detection unit 21e, an object detection unit 21f, and a heart rate detection sensor 26. The ATM 10 shown in FIG. 10 can communicate with a face authentication server 41 via a network.

The behavior estimation unit 21d, the facial expression detection unit 21e, and the object detection unit 21f are included in the monitoring and control unit 21. The heart rate detection sensor 26 is a sensor that detects the heart rate of the operator.

The behavior estimation unit 21d estimates the smoothness of the operation by the operator. If the smoothness of the operation is insufficient, the instruction unit 21c generates an instruction for supporting the operation by the operator.

The behavior estimation unit 21d estimates whether the operation is smooth or not using the stagnation of the operation, the facial expression of the operator, the heart rate of the operator and the like.

The stagnation of the operation can be determined by obtaining the state of the transaction in the transaction control unit 31, and comparing an estimated duration to the next operation with an actual duration of the operation.

The facial expression of the operator can be detected by the facial expression detection unit 21e applying image processing to an image of the face of the operator.

The heart rate of the operator can be detected by the heart rate detection sensor 26.

If stagnation occurs in the operation, the behavior estimation unit 21d estimates that the smoothness is low.

If the facial expression of the operator indicates confusion, the behavior estimation unit 21d estimates that the smoothness is low.

If the heart rate of the operator is high, the behavior estimation unit 21d estimates that the smoothness is low.

Besides of them, any of indicators including that the operator is about to operate differently from the procedure, accepts cancellation of the operation, and a confused motion is detected can be used to estimate the smoothness of the operation.

The behavior estimation unit 21d stores, in a predetermined storage unit, information related to the operation about which the smoothness is estimated to be insufficient. For example, the operations that the operator have been unable to perform smoothly are accumulated in the storage unit 22, thus allowing them to be used to improve the interface.

The instruction unit 21c associates information indicating the characteristics of the appearance of the person having performed a fraudulent action (e.g., a facial image, and the feature amount of the facial image) with information indicating the fraudulent action (e.g., the type of the malicious activity), and registers the associated information in the face authentication server 41, which is an external apparatus. As a result, fraudulent history data is accumulated in the face authentication server 41.

The instruction unit 21c can make an inquiry about the person imaged by the imaging unit 23, to the face authentication server 41. If there is a fraudulent history as a result of the inquiry, information obtained by a new transaction is associated, and registered in the face authentication server 41. For example, if the person having committed a malicious activity uses their own account or the like, the fraudulent action can be associated with their own identification information. If there is a fraudulent history as a result of the inquiry, an instruction about at least any of a notification, a warning, deferment, and attracting attention may be generated. That is, a new malicious activity is not required to be determined about a person having previously committed a malicious activity, and notification or the like can be performed.

The object detection unit 21f detects an object in a hand of the person by applying image processing to the imaging result of the imaging unit 23, and identifies the detected object.

If the object is an object related to a fraudulent action, the instruction unit 21c generates an instruction about a notification and/or a warning. The object related to the fraudulent action is an object that is not required for a transaction operation, an object that is possibly used to break the ATM 10, or the like.

The ATM 10 may include a display unit that can display an advertisement. The display unit that can display an advertisement may be part of the display and operation unit 32. Alternatively, another display unit may be provided.

The determination unit 21b can determine the line of sight of the person. The instruction unit 21c can switch the display of advertisement when the line of sight of the person turns to the display unit for displaying the advertisement.

Furthermore, the determination unit 21b can measure and record a time period during which the line of sight of the person faces the display unit for displaying the advertisement.

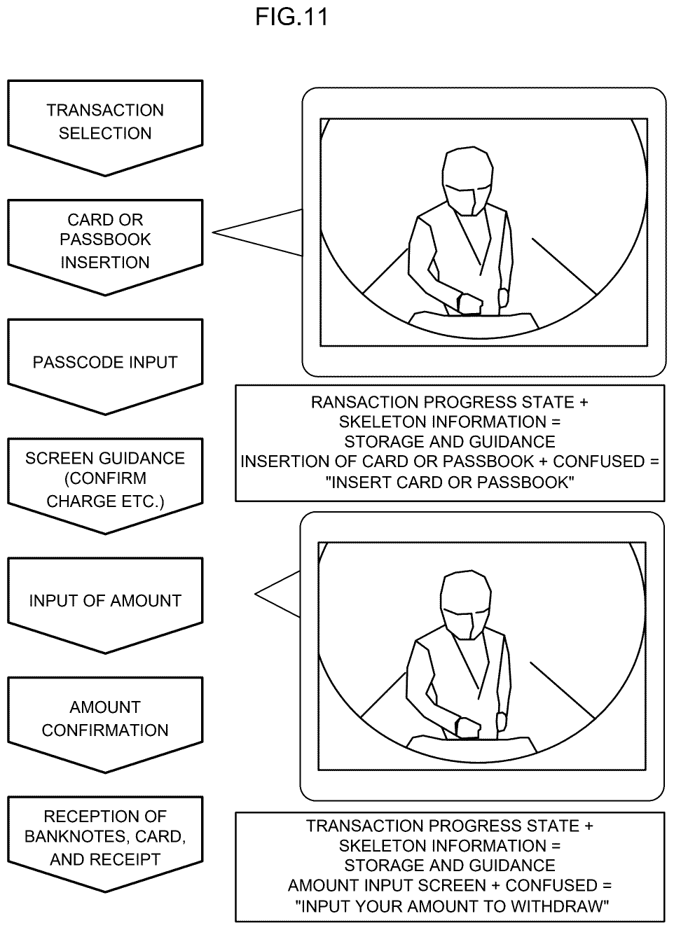

FIGS. 11 to 13 show specific examples of operation support.

A transaction exemplified in FIG. 11 is operated according to procedures of “TRANSACTION SELECTION”, “CARD OR PASSBOOK INSERTION”, “PASSCODE INPUT”, “SCREEN GUIDANCE (CONFIRM CHARGE ETC.)”, “INPUT OF AMOUNT”, “AMOUNT CONFIRMATION”, and “RECEPTION OF BANKNOTES, CARD, AND RECEIPT”.

In FIG. 11, if the transaction progress state is “CARD OR PASSBOOK INSERTION” and the skeleton information indicates that the operator is confused, the instruction unit 21c supports the operation of the operator by outputting guidance “CARD OR PASSBOOK INSERTION”. If the transaction progress state is “INPUT OF AMOUNT screen” and the skeleton information indicates that the operator is confused, the instruction unit 21c supports the operation of the operator by outputting guidance “INPUT YOUR AMOUNT TO WITHDRAW”.

The determination is performed with reference to the behavior of the operator of the ATM 10 and the stage of the behavior in the transaction procedure in a combined manner as described above, which allows the ATM 10 to output appropriate guidance. The guidance may be a displayed indication or a sound, or control for highlighting a position to be operated, such as intense blinking at a card port.

While providing the operation guidance, the ATM 10 stores which stage in the operation the operator is confused in the transaction procedure. Accordingly, when the same person operates at the next time, the guidance is changed such that the operation is made easily understandable at the same scene, and positions or steps at which many users get lost in the operation are collected as big data, which can contribute to improvement in guidance.

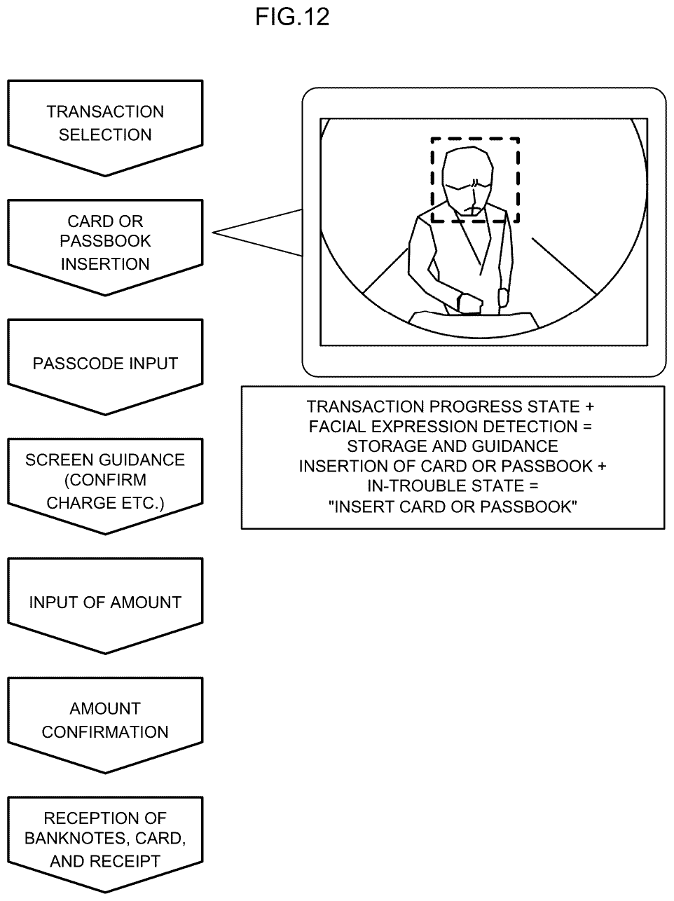

FIG. 12 shows that the transaction progress state is “CARD OR PASSBOOK INSERTION”, and confusion is identified by detecting the facial expression. Accordingly, the instruction unit 21c supports the operation of the operator by outputting guidance “INSERT CART OR PASSBOOK”. The ATM 10 stores which stage in the operation the operator is confused in the transaction procedure.

As described above, the stage in the transaction at which the user is confused, and its frequency are stored in combination with facial authentication and transaction account information, which can achieve measures for advancing the timing of the operation support, for frequently confused users and procedures. A confused face or an annoyed face may be determined by detecting any of facial expressions and motions that include, for example, frowning, lowered tails of eyes, and the inclined head.

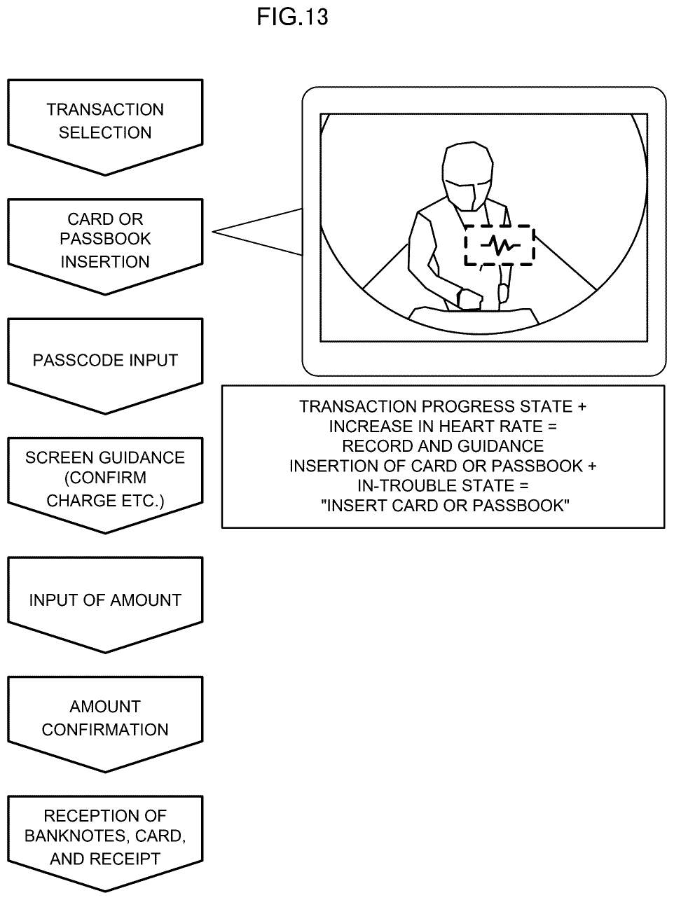

In FIG. 13, the transaction progress state is “CARD OR PASSBOOK INSERTION”, and an in-trouble state is estimated based on increase in heart rate. Accordingly, the instruction unit 21c supports the operation of the operator by outputting guidance “INSERT CART OR PASSBOOK”. The ATM 10 stores which stage in the operation the operator is confused in the transaction procedure.

The heart rate can perform non-contact measurement by detecting fine vibrations on the body surface with a millimeter-wave radar. When the behavior estimation unit 21d detects that the heart rate increases, this unit estimates an anxious state such as of an unknown procedure, or a restless state such as of a bank transfer scam.

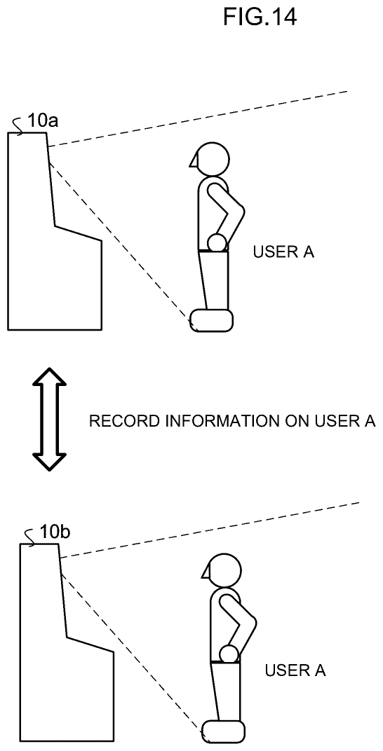

FIG. 14 is a diagram illustrating sharing of a fraudulent history. In FIG. 14, a user A performs a fraudulent action at an ATM 10a, and subsequently operates an ATM 10b installed at a different position.

The ATM 10a records information on the person having performed the fraudulent action, in the external apparatus, thus sharing the information. Upon detection of the person at any ATM thereafter, the information on the person is associated. Accordingly, information usable for identification, such as account information on the person having performed the fraudulent action, can be accumulated.

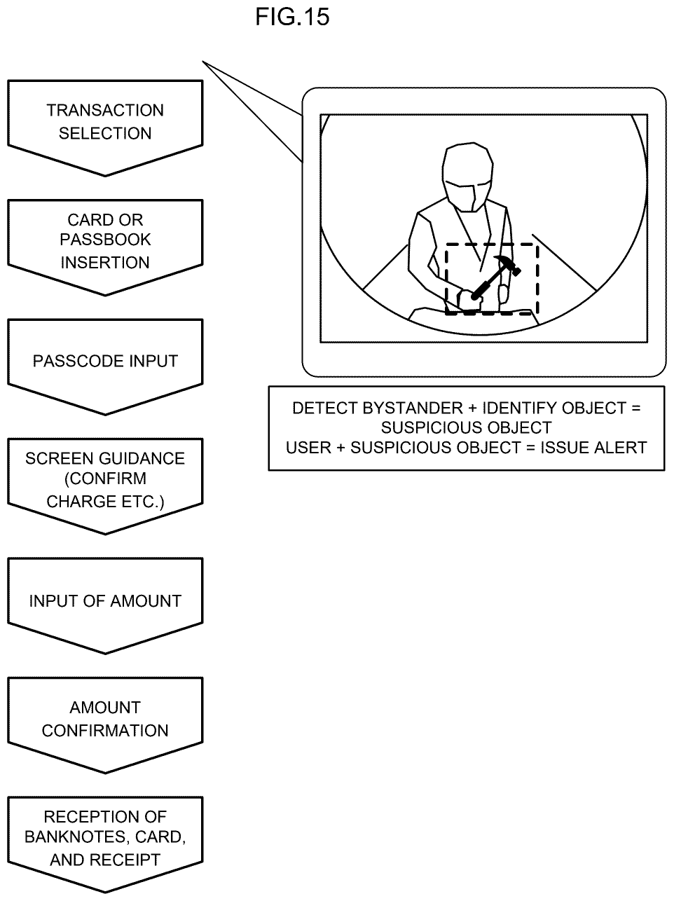

FIG. 15 is a diagram illustrating detection of an object. If the ATM 10 detects an object in a hand of an adjacent person, and the detected object is an object unnecessary for operating the ATM 10 or an object possibly used to break the ATM 10, the ATM 10 issues an alert. The alert may be a notification to a security guard room or the like, or a warning to adjacent people. For example, an audio message “A staff member will be with you. Please wait a moment” is issued loudly. As described above, the alert is issued in a state of holding a suspicious object before a fraudulent action is performed, which can facilitate prevention of the fraudulent action.

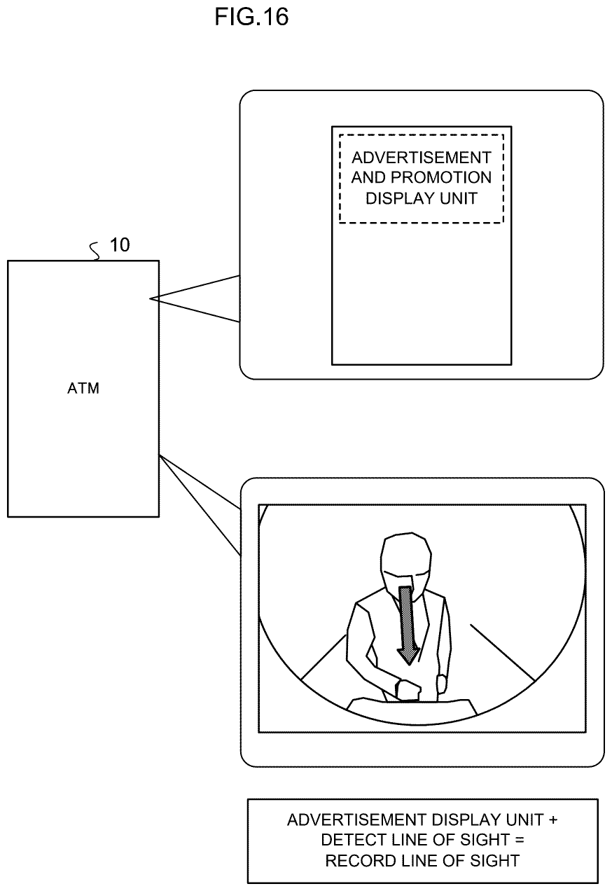

FIG. 16 is a diagram illustrating advertisement display. The ATM 10 can display advertisements and promotions and the like. For example, part of the display area of the display and operation unit 32 used for a transaction may be used to display advertisements for the operator. A display unit for advertisements may be separately provided above the ATM 10 so as to be viewable from people therearound.

The ATM 10 detects the lines of sight of the operator and the bystanders through image processing or the like. When the ATM 10 detects the line of sight turns to the display area for advertisements, display content is switched and an advertisement is displayed. Furthermore, by measuring and recording a time period during which the line of sight faces the display unit, an evaluation material for the content of the advertisement can be accumulated. Furthermore, the content of the advertisement may be determined in corporation with user information and transaction content. For example, conditions that include “If the account balance is low but withdrawal or transfer is performed, an advertisement of a loan is provided” and “if the account balance is high and a deposit is performed, asset management guidance is provided” may be used.

As described above, the ATM 10 that internally has a function as a monitoring apparatus includes: the imaging unit 23 that includes, in the imaging range, an operator of a money handling transaction apparatus and surroundings of the operator; the posture detection unit 21a that detects a joint position related to a skeleton in an image of a person included in an imaging result of the imaging unit 23; the determination unit 21b that determines a motion of the person, based on a detection result of the posture detection unit 21a; and the instruction unit 21c that generates an instruction that indicates a response to the person, based on a determination result of the determination unit 21b.

The determination unit 21b compares the determination result of the posture detection unit 21a with the operator motion pattern data 22a that is defined in advance about the motion of the operator, and determines the motion of the person. The instruction unit 21c refers to the instruction pattern data 22d that associates the motion with the instruction, and generates the instruction.

According to such a configuration and operation, the monitoring apparatus can achieve highly functional monitoring in relation to operations on the money handling transaction apparatus. Specifically, the monitoring apparatus can prevent criminal actions, such as destructive actions to the ATM 10, and fraudulent access to user information, and improve the usability of the user of the ATM 10.

The determination unit 21b can further use the bystander motion pattern data 22b that is defined in advance about the motion of a bystander present around the operator, and determines the motion of the bystander. The instruction unit 21c can generate the instruction using the motion of the operator and the motion of the bystander.

Furthermore, the instruction unit 21c can generate an instruction for a situation identified according to a combination of the motion of the operator and the motion of the bystander.

Accordingly, using the possibility that people around the transaction apparatus perform a specific motion, such as waiting for their turn, the motions of the operator and people therearound are comprehensively determined, and an appropriate instruction can be generated.

The determination unit 21b further uses a state of a transaction obtained from the transaction apparatus, and determines the motion of the person.

The determination unit 21b can compare the detection result of the posture detection unit 21a with transaction operation procedure data 22c indicating an operation procedure of the transaction apparatus and identify a state of the transaction, and further use the state of the transaction and determine the motion of the person.

By obtaining the state of the transaction as described above, the motion of the operator can be determined in more detail.

If the operation of the operator deviates from an appropriate operation procedure, the instruction unit 21c generates an instruction for supporting the operation of the operator.

Accordingly, the monitoring apparatus can contribute to improvement in user-friendliness of the operator.

If the motion of the person is a fraudulent action, the instruction unit 21c generates an instruction for at least any of a notification, a warning, deferment, and attracting attention.

Accordingly, the monitoring apparatus can appropriately prevent the fraudulent action.

The monitoring apparatus further includes a microphone and/or a vibration sensor. The determination unit 21b further uses output of the microphone and/or the vibration sensor, and determines the motion of the person.

Accordingly, a destructive action and a fraudulent process can be highly accurately determined.

The instruction unit 21c generates an instruction for canceling and starting the power saving mode of the transaction apparatus, based on an approach and a departure of the operator.

Accordingly, start and cancellation of the power saving mode can be highly accurately performed.

The monitoring apparatus further includes a behavior estimation unit 21d as an estimation unit that estimates the smoothness of the operation of the operator. If the smoothness of the operation is insufficient, the instruction unit 21c generates an instruction for supporting the operation of the operator.

Accordingly, appropriate guidance can be provided for the operator early on, and the usability can be improved.

For example, in the monitoring apparatus, the estimation unit determines stagnation of the operation, based on a state of a transaction obtained from the transaction apparatus and on a duration of the operation, and estimates the smoothness of the operation using a determination result of the stagnation.

For example, the monitoring apparatus further includes the facial expression detection unit 21e that detects the facial expression of the operator from the imaging result of the imaging unit. The estimation unit determines whether the operator is confused or not based on the facial expression of the operator, and estimates the smoothness of the operation using the determination result.

For example, the monitoring apparatus further includes the heart rate detection sensor 26 that detects the heart rate of the operator. The estimation unit estimates the smoothness of the operation using the heart rate.

As described above, the smoothness of the operation can be comprehensively estimated using the transaction state, duration of the operation, facial expression, heart rate and the like.

The estimation unit stores, in a predetermined storage unit, information related to the operation about which the smoothness is estimated to be insufficient.

Accordingly, it can be used to improve the operability, such as change in guidance when the same person performs the operation at the next time, and improvement in the operation that is difficult for many people to understand.

If the motion of the person is a fraudulent action, the instruction unit 21c registers, in the external apparatus, a fraudulent history that associates information indicating the characteristics of the appearance of the person with information indicating the fraudulent action. If there is a fraudulent history as a result of referring to the external apparatus about the person imaged by the imaging unit 23, the instruction unit 21c registers, in the external apparatus, information obtained by a new transaction by the person in association with the history.

By thus accumulating the information obtained from transactions thereafter about the person having performed the fraudulent action, information on the person having performed the malicious activity can be collected.

The monitoring apparatus further includes the object detection unit 21f that detects an object in a hand of the person, and identifies the detected object. If the object is an object related to a fraudulent action, the instruction unit 21c generates an instruction about a notification and/or a warning.

Accordingly, the fraudulent action can be prevented.

The monitoring apparatus further includes a display unit that can display an advertisement. The determination unit 21b determines the line of sight of the person. The instruction unit 21c switches the displayed advertisement when the line of sight of the person turns to the display unit.

The determination unit 21b measures and records a time period during which the line of sight of the person faces the display unit.

Accordingly, an effective advertisement can be provided for the person using the transaction apparatus.

Note that the present invention is not limited to the aforementioned Examples, and encompasses various modified examples. For example, the aforementioned Examples are described in detail to illustrate the present invention in an easily understandable manner. There is not necessarily a limitation to what includes all the described components. Without limitation to removal of such components, components may be replaced and added.

For example, in the aforementioned Examples, the description is performed using the example in which the function as the monitoring apparatus is internally included in the ATM, which is the transaction apparatus. Alternatively, the monitoring apparatus may be an apparatus different from the transaction apparatus. In the case of the different apparatus, it can be coupled to the transaction apparatus. In the case without coupling, various instructions are not output to the transaction apparatus. Alternatively, instruction for the speaker or a communication function that the monitoring apparatus includes are generated.

In the above Examples, the case in which the present invention is applied to the ATM is exemplified. However, the present invention is also applicable to any of transaction apparatuses, such as a ticket vending machine, an automatic vending machine, and a foreign currency exchange machine.

### Reference Signs List

10: ATM, 21: Monitoring and control unit, 21a: Posture detection unit, 21b: Determination unit, 21c: Instruction unit, 21d: Behavior estimation unit, 21e: Facial expression detection unit, 21f: Object detection unit, 22: Storage unit, 22a: Operator motion pattern data, 22b: Bystander motion pattern data, 22c: Transaction operation procedure data, 22d: Instruction pattern data, 23: Imaging unit, 24: Vibration sensor, 25: Microphone, 26: Heart rate detection sensor, 31: Transaction control unit, 32: Display and operation unit, 33: Speaker, 34: Money storage unit, 35: Deposit and withdrawal unit, 41: Face authentication server

1. A monitoring apparatus, comprising:
an imaging unit that includes, in an imaging range, an operator of a money handling transaction apparatus and surroundings of the operator;
a posture detection unit that detects a joint position related to a skeleton in an image of a person included in an imaging result of the imaging unit;
a determination unit that determines a motion of the person, based on a detection result of the posture detection unit; and
an instruction unit that generates an instruction that indicates a response to the person, based on a determination result of the determination unit, wherein
the determination unit determines the motion of the person by comparing the detection result of the posture detection unit with operator motion pattern data that is defined in advance about a motion of the operator, and
the instruction unit refers to instruction pattern data that associates the motion with the instruction, and generates the instruction.

2. The monitoring apparatus according to claim 1, wherein
the determination unit further uses bystander motion pattern data that is defined in advance about a motion of a bystander present around the operator, and determines the motion of the person, and
the instruction unit uses the motion of the operator and the motion of the bystander, and generates the instruction.

3. The monitoring apparatus according to claim 2, wherein
the instruction unit can generate an instruction for a situation identified according to a combination of the motion of the operator and the motion of the bystander.

4. The monitoring apparatus according to claim 1, wherein
the determination unit further uses a state of a transaction obtained from the transaction apparatus, and determines the motion of the person.

5. The monitoring apparatus according to claim 1, wherein
the determination unit compares the detection result of the posture detection unit with transaction operation procedure data indicating an operation procedure of the transaction apparatus and identifies a state of a transaction, and further uses the state of the transaction and determines the motion of the person.

6. The monitoring apparatus according to claim 1, wherein
when an operation of the operator deviates from an appropriate operation procedure, the instruction unit generates an instruction for supporting the operation of the operator.

7. The monitoring apparatus according to claim 1, wherein
when the motion of the person is a fraudulent action, the instruction unit generates an instruction for at least any of a notification, a warning, deferment, and attracting attention.

8. The monitoring apparatus according to claim 1, further comprising
a microphone and/or a vibration sensor, wherein an output of the microphone and/or the vibration sensor is further used, and the motion of the person is determined.

9. The monitoring apparatus according to claim 1, wherein
the instruction unit generates an instruction for canceling and starting a power saving mode of the transaction apparatus, based on an approach and a departure of the operator.

10. A monitoring method causing a monitoring apparatus to perform:
an imaging step of imaging an operator of a money handling transaction apparatus, and surroundings of the operator;
a posture detection step of detecting a joint position related to a skeleton in an image of a person included in an imaging result of the imaging step;
a determination step of determining a motion of the person, based on a detection result of the posture detection step; and
an instruction step of generating an instruction that indicates a response to the person, based on a determination result of the determination step, wherein
the determination step determines the motion of the person by comparing the detection result of the posture detection step with operator motion pattern data that is defined in advance about a motion of the operator, and
the instruction step refers to instruction pattern data that associates the motion with the instruction, and generates the instruction.

11. The monitoring apparatus according to claim 1, further comprising
an estimation unit that estimates smoothness of an operation of the operator, wherein
when the smoothness of the operation is insufficient, the instruction unit generates an instruction for supporting the operation of the operator.

12. The monitoring apparatus according to claim 11, wherein
the estimation unit determines stagnation of the operation, based on a state of a transaction obtained from the transaction apparatus and on a duration of the operation, and estimates the smoothness of the operation using a determination result of the stagnation.

13. The monitoring apparatus according to claim 11, further comprising
a facial expression detection unit that detects a facial expression of the operator from the imaging result of the imaging unit, wherein
the estimation unit determines whether the operator is confused or not based on the facial expression of the operator, and estimates the smoothness of the operator using the determination result.

14. The monitoring apparatus according to claim 11, further comprising
a heart rate detection sensor that detects a heart rate of the operator, wherein
the estimation unit estimates the smoothness of the operator using the heart rate.

15. The monitoring apparatus according to claim 11, wherein
the estimation unit stores, in a predetermined storage unit, information related to an operation about which the smoothness is estimated to be insufficient.

16. The monitoring apparatus according to claim 1, wherein
when the motion of the person is a fraudulent action, the instruction unit registers, in an external apparatus, a fraudulent history that associates information indicating characteristics of an appearance of the person with information indicating the fraudulent action, and
when the fraudulent history is present as a result of reference to the external apparatus about a person imaged by the imaging unit, the instruction unit registers, in the external apparatus, information obtained from a new transaction of the person in association with the fraudulent history.

17. The monitoring apparatus according to claim 1, further comprising
an object detection unit that detects an object in a hand of the person, and identifies the detected object, wherein
when the object is an object related to a fraudulent action, the instruction unit generates an instruction about a notification and/or a warning.

18. The monitoring apparatus according to claim 1, further comprising
a display unit that can display an advertisement, wherein
the determination unit determines a line of sight of the person, and
the instruction unit switches the displayed advertisement when the line of sight of the person turns to the display unit.

19. The monitoring apparatus according to claim 18, wherein
the determination unit measures and records a time period during which the line of sight of the person faces the display unit.
